(19) United States
(12) Patent Application Publication
(10) Pub. No.: US 2006/0247090 A1
(43) Pub. Date: Nov. 2, 2006

(54) Toroidal type continuously variable transmission

(75) Inventors: Hiroki Nishii, Kanagawa (JP); Nobuo Goto, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NSK LTD.

(21) Appl. No.: 11/415,233

(22) Filed: May 2, 2006

(30) Foreign Application Priority Data
May 2, 2005 (JP) P.2005-133924

(51) Int. Cl. F16H 15/38

(52) U.S. Cl. 476/40

(57) ABSTRACT

A toroidal type continuously variable transmission which maintains a gear ratio stably and continue to use the same gear ratio control even for a different model type of support shaft for supporting rotatably a power roller which differs in shaft diameter. A power roller 11 is rotatably supported by a displacement shaft 31 which protrudes from a trunnion 6 and a thrust ball bearing 39 provided between the power roller 11 and the trunnion 6. A secondary shaft portion 34 of the displacement shaft 31 is fittingly inserted into a hole 41a in an outer race 41 of the thrust ball bearing 39. A clearance between the hole 41a in the outer race 41 and the secondary shaft portion 34 is set in a range from 0 to 0.05 mm.

The present invention claims foreign priority to Japanese patent application No. P.2005-133924, filed on May 2, 2005, the contents of which is incorporated herein by reference.

### BACKGROUND OF THE INVENTION

1. Field of the Invention

The present invention relates to a toroidal type continuously variable transmission which can be applied for transmissions or the like for automobiles and various types of industrial machines.

2. Description of the Background Art

A toroidal type continuously variable transmission as shown in FIGS. 5 and 6 is partially implemented as a transmission for a vehicle. In this toroidal type continuously variable transmission, an input disk 2 is supported concentrically with an input shaft 1, and an output disk 4 is fixed to an end portion of an output shaft 3 which is disposed concentrically with the input shaft 1. Trunnions 6, 6 are provided inside a casing which accommodates therein the toroidal type continuously variable transmission in such a manner as to swing around pivot shafts (tilting shafts) 5, 5 which are situated at positions twisted relative to the input shaft 1 and the output shaft 3 (both of the shaft are equivalent to a central axis of the input disk 2 and the output disk 4). The power rollers 11, 11 are supported rotatably on the trunnions 6, 6, respectively, and are held between the input and output disks 2, 4 in rolling contact therewith.

Inner surfaces 2a, 4a of the input and output disks 2, 4 which oppose to each other are formed into a concave shape in cross-section. The concave shape is a shape obtained by rotating an arc centered at the pivot shaft 5 or obtained by rotating a curved line which is like the arc. In addition, respective circumferential surfaces 11a, 11a of the power rollers 11, 11 which are formed into a spherically convex surface are brought into abutment with the inner surfaces 2a, 4a, respectively.

A loading cam type pressing device (hereinafter, referred to as a loading mechanism) 12 is provided between the input shaft 1 and the input disk 2. This loading mechanism 12 resiliently presses the input disk 2 towards the output disk 4. In addition, the loading mechanism 12 includes a cam plate 13 which rotates together with the input shaft 1 and a plurality (for example, four) of rollers 15 which are retained by a cage 14. Additionally, a cam surface 16, which is one side surface of the cam plate (a left side in FIGS. 5 and 6), is formed so as to be irregular (wavy) in a circumferential direction thereof, and a similar cam surface 17 is formed on an outer surface (a right side in FIGS. 5 and 6) of the input disk 2. Then, the plurality of rollers 15 are supported so as to be rotatable about axes which extend radially relative to the input shaft 1.

In the above-described toroidal type continuously variable transmission, when the input shaft 1 is rotated, the cam plate 13 rotates in association with the rotation of the input shaft 1, and the plurality of rollers 15, 15 are pressed against the cam surface 17 provided on the outer side of the input disk 2 by the cam surface 16. As a result, the input disk 2 is pressed against by the plurality of power rollers 11, 11, and at the same time, the input disk 2 rotates based on the pair of cam surfaces 16, 17 being pressed against rolling surfaces of the plurality of rollers 15, 15. Then, the rotation of the input disk 2 is transmitted to the output disk 4 via the individual power rollers, whereby the output shaft 3 fixed to the output disk 4 is caused to rotate.

In trying to change the rotational speed of the input shaft 1 and the output shaft 3, when trying to reduce the speed between the input shaft 1 and the output shaft 3, the trunnions 6, 6 are caused to swing around the pivot shafts 5, 5, respectively, and displacement shafts 9, 9 are tilted so that the respective circumferential surfaces 11a, 11a of the power rollers 11, 11 are brought into abutment with a portion on the inner surface 2a of the input disk 2 which lies closer to the center of the inner surface 2a and a portion on the inner surface 4a of the output disk 4 which lies closer to the outer circumference of the inner surface 4a, respectively, as shown in FIG. 5.

On the contrary, when trying to increase the speed therebetween, the individual trunnions 6, 6 are caused to swing, and the displacement shafts 9, 9 are tilted so that the respective circumferential surfaces 11a, 11a of the power rollers 11, 11 are brought into abutment with a portion on the inner surface 2a of the input disk 2 which lies closer to the outer circumference of the inner surface 2a and a portion on the inner surface 4a of the output disk 4 which lies closer to the center of the inner surface 4a, respectively, as shown in FIG. 6. In the event that respective tilt angles of the displacement shafts 9, 9 are made to lie at an intermediate angle between those shown in FIGS. 5 and 6, an intermediate speed or gear ratio is obtained between the input shaft 1 and the output shaft 3.

A more specified example of a double-cavity toroidal type continuously variable transmission is shown in FIGS. 7 and 8. Hereinafter, like reference numerals are imparted to like constituent members to those shown in FIGS. 5 and 6, so that a detailed description or illustration thereof will be omitted.

As shown in these figures, an input shaft 1 is supported rotatably inside a casing 101. Primary and secondary input disks 2, 2 are supported on the input shaft 1 at portions closer to ends thereof via ball splines 96, respectively. In this case, the primary and secondary input disks 2, 2 are disposed concentrically with each other in such a state that respective inner surfaces 2a, 2a thereof are made to oppose to each other and are capable of rotating in the casing 101 in synchronism with each other.

Primary and secondary output disks 4, 4 are supported on an outer circumference of an intermediate portion of the input shaft 1 via a sleeve 109. An output gearwheel 110 is integrally provided on an outer circumferential surface of an intermediate portion of the sleeve 109. The output gearwheel 110 is disposed concentrically with the input shaft 1 and has a larger inner diameter than an outside diameter of the input shaft 1. In addition, the output gearwheel 10 is supported rotatably on a support wall 111 provided within the casing 101 via a pair of roller bearings 112.

The primary and secondary output disks 4, 4 are brought into spline engagement with end portions of the sleeve 109, respectively. In this case, the output disks 4, 4 are disposed back to back so that respective inner surfaces 4a, 4a are made to face an opposite direction to each other. Consequently, the input disk 2 and the output disk 4 are disposed in such a state that the respective inner surfaces 2a, 4a thereof are made to face each other.

As shown in FIG. 8, pairs of yokes 113a, 113b are supported at positions inside the casing 101 and sideways of the output disks 4, 4 in such a state that the yokes hold both the disks 4, 4 therebetween from both sides of the disks. These pairs of yokes 113a, 113b are formed into a rectangular shape by pressing or forging metal such as steel. In addition, in order to support pivot shafts 5 provided at both end portions of trunnions 6, which will be described later on, in such a manner as to freely swing, a circular support hole 18 is provided in end portions of each of the yokes 113a, 113b, and a circular lock hole 119 is provided in a transversely central portion of each of the yokes 113a, 113b.

The pair of yokes 113a, 113b are supported, respectively, by support posts 20a, 20b which are formed at portions on inner surfaces of the casing 101 which face each other in such a manner as to be displaced slightly. These support posts 20a, 20b are provided in each of a first cavity 21 and a second cavity 22 which are defined by the inner surfaces 2a of the input disks 2 and the inner surfaces 4a of the output disks 4, respectively, so as to oppose to each other. A tilt stopper 150 is provided on the post 20a for restricting the tile amount of the trunnions 6.

Consequently, with supported by the support posts 20a, 20b, respectively, the yokes 113a, 113b oppose to an outer circumferential portion of the first cavity 21 at one end portion and an outer circumferential portion of the second cavity 22 at the other end portion thereof.

Since the first and second cavity 21, 22 have the same construction, only the first cavity 21 will be described below.

A pair of trunnions 6 are provided in the first cavity 21. Pivot shafts 5 are provided at both ends of each of the trunnions 6 concentrically, and these pivot shafts 5 are supported at one end of the pair of yokes 113a, 113b in such a manner as to be shifted axially freely as well as swing freely. Namely, the pivot shafts 5 are supported inside the support holes 118 which are formed at the one end of the yokes 113a, 113b by means of radial needle roller bearings 26, respectively. The radial needle roller bearing 26 is made up of an outer race 27 having an outer circumferential surface which makes a spherically convex surface and an inner circumferential surface which makes a cylindrical surface and a plurality of needles 28.

A circular hole 30 is provided in an intermediate portion of each trunnion 6. In addition, a displacement shaft 31 is supported in each circular hole 30. Each displacement shaft 31 has a primary shaft portion 33 and a secondary shaft portion 34 which are parallel and eccentric to each other. The primary shaft portion 33 is supported inside the circular hole 30 via a radial needle roller bearing 35. The power roller 11 is supported around the secondary shaft portion 34 via another radial needle roller bearing 38.

The displacement shafts 31 (the support shafts), which are provided in pair for each of the first and second cavities 21, 22, are provided so as to oppose to each other across the input shaft 1 in each of the first and second cavities 21, 22. A direction in which the secondary shaft portion 34 is eccentric to the primary shaft portion 33 on one of the displacement shafts 31 is identical to a direction in which the secondary shaft portion 34 is eccentric to the primary shaft portion 33 on the other with respect to the rotational direction of the input disks 2, 2 and the output disks 4, 4. The eccentric directions, in which the relevant shaft portions are eccentric to each other, intersect substantially at right angles relative to a longitudinal axis of the input shaft 1. Consequently, the power rollers 11 are supported in such a manner as to be displaced slightly along a longitudinal direction of the input shaft 1. As a result, even though there occurs a case where the power rollers 11 tend to be displaced in an axial direction of the input shaft 1 due to change in an elastic deformation amount of the constituent members generated by change in torque transmitted by the toroidal continuously variable transmission, no excessive force is applied to the constituent members in any case, and the displacement of the power rollers 11 can be absorbed.

A thrust ball baring 39 and a thrust bearing 40 such as a sliding bearing or a needle roller bearing are provided in this order as viewed from an outer surface of the power roller 11, and also provided between the outer surface of the power roller 11 and an inner surface of an intermediate portion of the trunnion 6. The thrust ball bearing 39 permits the rotation of the power roller while bearing a load applied to the power roller 11 in a thrust direction. The thrust bearing 40 permits the swing of the secondary shaft portion 34 and an outer race 41 of the thrust ball bearing 39 around the primary shaft portion 33 while bearing a thrust load applied to the outer ring 41 from the power roller 11.

A driving rod 42 is connected to one end portion of each trunnion 6. In addition, driving pistons 43 are secured to an outer circumferential surface of an intermediate portion of the driving rod 42. The driving pistons 43 are fitted within a driving cylinder 44 in fluid tight manner to thereby form an actuator (a driving device) for displacing the trunnion 6 in the axial direction.

As shown in FIG. 7, a loading cam type pressing device 45 is provided between a drive shaft 200 for transmitting power from an engine and one of the input disks 2. The input disk 2 is made free to be driven rotationally while being elastically pressed towards the output disk 4 by this pressing device 45. The pressing device 45 includes a loading cam (a cam plate) 46 which rotates together with the drive shaft 200 and a plurality (for example, four) of rollers 48 retained rollingly by a cage 47. A cam surface 46a which is a series of irregularities (a wavy portion) circumferentially is formed on one side (a right side in FIG. 7) of the loading cam 46, and a cam surface 2b having a similar shape is also formed on an outer surface (a left side in FIG. 7) of the input disk 2. An angular ball bearing (an angular bearing) 210 is interposed between an end portion of the input shaft 1 and the loading cam 46. Furthermore, the loading cam 46 fittingly connects to a fitting portion 200a of the drive shaft 200 at a claw portion 46b thereof.

When the toroidal type continuously variable transmission which is configured as has been described above is operated, the rotation of the drive shaft 200 is transmitted to the one of the input disks 2 via the pressing device 45, and this input disk 2 and the other input disk 2 rotate together with the input shaft 1 while being synchronized with each other. The rotation of the input disks 2, 2 is transmitted to the output disks 4, 4 via the power rollers 11. The rotation of the output disks 4, 4 are taken out from the output gearwheel 110.

When changing the rotational speed ratio between the input shaft 1 and the output gearwheel 110, the driving pistons 43, which are provided in pair for each of the first and second cavities 21, 22, are shifted for the same distance in opposite directions to each other in each of the first and second cavities 21, 22 based on by switching a not shown control valve (on and off). The trunnions 6, which are provided in pairs of four in total, are displaced in opposite directions to each other in each of the pairs in association with the displacement of the driving pistons 43, whereby one of the power rollers 11 is displaced downwards, whereas the other power roller 11 is displaced upwards. As a result, the directions of tangential forces are changed which are applied to abutment portions between the circumferential surfaces 11a, 11a of the power rollers 11 and the inner surfaces 2a, 2a of the input disks 2, 2 and the inner surfaces 4a, 4a of the output disks 4, 4. Then, the trunnions 6 swing in opposite directions to each other around the pivot shafts 5 which are pivotally supported on the yokes 113a, 113b. As a result, the positions where the circumferential surfaces of the power rollers 11 are in abutment with the input disks 2, 2 and the output disks 4, 4 are changed, whereby the rotational speed ratio between the input shaft 1 and the output gearwheel 110 is changed.

As has been described before, the power roller 11 is supported around the secondary shaft portion 34, which is eccentric, of the displacement shaft 31 functioning as the support shaft via the radial needle roller bearing.

In addition, the thrust ball bearing 39, which permits the rotation of the power roller 11 while bearing the load applied to the power roller 11 in the thrust direction, is disposed between the power roller and the trunnion 6. The outer race 41 of the thrust ball bearing 39 has a hole formed in a central portion thereof so that the secondary shaft portion 34 passes therethrough, and the secondary shaft portion 34 is socket fitted in the hole so formed (for example, refer to Japanese Patent Unexamined Publication No. JP-A-11-210854).

In addition, the primary shaft portion 33 of the displacement shaft 31 is supported in the circular hole 30 formed in the trunnion 6 via the radial needle roller bearing 35. Additionally, the trust bearing 40, which permits the swing of the secondary shaft portion 34 and the outer race 41 around the primary shaft portion 33 while bearing the thrust load applied to the outer race 41 of the thrust ball bearing 39 from the power roller 11, is disposed between the outer race 41 of the thrust ball bearing 39 and the trunnion 6.

Here, since a radial clearance exists basically in the radial needle roller bearings 35, 38 and furthermore, crowning is applied to needles of the bearings in order to prevent the concentration of load onto end portions thereof, there is caused a problem that the displacement shaft 31 and the power roller 11 tend to be easily tilted towards the trunnion 6 and the displacement shaft 31, respectively. Furthermore, since the fitting of the secondary shaft portion 34 of the displacement shaft 31 in the hole in the outer race 41 makes quite a loose fit in order to facilitate the assembly thereof easily, the aforesaid tilting of the displacement shaft 31 cannot be suppressed even though the secondary shaft portion 33 of the displacement shaft 31 fits in the outer race 41.

In other words, when the power roller 11 receives thrust force, the rotational center of the power roller 11 is allowed to move towards the pivot shaft. Because a clearance amount, which is formed in the fitting between the hole in the outer race 41 and the secondary shaft portion 34 of the displacement shaft 31, allows some extent of tilting of the displacement shaft 31 relative to the trunnion 6 and tilting of the power roller 11 relative to the displacement shaft 31. In addition, in the event that there occurs a change in the direction of a tangential force which the power roller 11 receives from the input disk 2 and the output disk as when there occurs a change in the magnitude of torque that is transmitted through the toroidal type continuously variable transmission, the rotational center of the power roller 11 moves toward the pivot shaft 5 to thereby be offset.

Namely, when there occurs a torque change as described above, the rotational center of the power roller 11 is offset according, to some extent, to the amount of clearance formed between the hole in the outer race 41 and the secondary shaft portion 34 of the displacement shaft 31 fitted in the hole.

Normally, in the toroidal type continuously variable transmission, the gear ratio is changed by the movement of the trunnion 6, which supports the power roller 11, towards the pivot shaft 5 as described above. However, even though the trunnion 6 does not move, the gear ratio is also changed by the offset of the rotational center of the power roller 11 towards the pivot shaft 5 as has been described above (for example, refer to Japanese Patent Unexamined Publication).

Incidentally, it is seen from what has been described above that since, in the event that the clearance produced when the secondary shaft portion 34 of the displacement shaft 31 fits in the hole in the outer race 41 varies largely, the aforesaid offset amount of the power roller 11 is varied depending on individual toroidal type continuously variable transmissions, the offset amount of the power roller 11 differs even on toroidal type continuously variable transmissions of the same model (namely, even though their respective target gear ratios are the same). Therefore, the same gear ratio cannot be obtained depending on situations. In addition, the amount of torque shift, which occurs when the torque reverses, is not stabilized. Furthermore, in the event that the difference in clearance amount between the four power rollers is increased, there is generated a synchronization collapse, leading to a problem of occurrence of unstable synchronization or reduced durability.

In addition, the clearance produced when the secondary shaft portion 34 of the displacement shaft 31 fits in the hole in the outer race 41 is different depending on shaft diameters (inner diameters of holes) as indicated in Table 1 which describes dimension tolerances which are used in normal fitting. Note that Table 1 is pursuant to Japanese Industrial Standard (JIS) B0401, and the Tolerance region examples of Table 1 (H6, h6 and etc.) indicate grades which are referred in manufacturing members fitted each other.

TABLE 1

| | Tolerance | Hole | Shaft | |
|---|---|---|---|---|
| Reference | Region | Dimension | Dimension | Clearance |
| Dimensions | Examples | Tolerances | Tolerances | Amounts |
| 10˜18 | H6, h6 | 0˜11 | −11˜0 | 22 |
| | H7, h7 | 0˜18 | −18˜0 | 36 |
| | H8, h8 | 0˜27 | −27˜0 | 54 |
| 18˜30 | H6, h6 | 0˜13 | −13˜0 | 26 |
| | H7, h7 | 0˜21 | −21˜0 | 42 |
| | H8, h8 | 0˜33 | −33˜0 | 66 |
| 30˜50 | H6, h6 | 0˜16 | −16˜0 | 32 |
| | H7, h7 | 0˜25 | −25˜0 | 50 |
| | H8, h8 | 0˜39 | −39˜0 | 78 |

unit: μm

Table 1 shows hole dimension tolerances (μm) and shaft dimension tolerances (μm) for reference dimensions (shaft diameters, inner diameters of holes (μm)) which are tended to be used in many occasion at fitting the secondary shaft portion 34 in the outer race 41 of toroidal type continuously variable transmissions and individual tolerance region classes (H6 to H8 (holes) and h6 to h8 (shafts)), as well as clearance amounts (maximum clearance amounts (μm)) based on the tolerances.

As shown in Table 1, when designing fittings, the clearance amount increases as the shaft diameter increases. Consequently, when there occurs a design change in the shaft diameter of the secondary shaft portion 34 or in a toroidal type continuously variable transmission whose secondary shaft portion 34 has a different shaft diameter, the clearance amount is designed differently. Accordingly, the aforesaid offset amount of the power roller 11 differs thereamong. Thus, as has been described above, even though the target gear ratios are the same, the same gear ratio cannot be obtained. Consequently, when changing the shaft diameter of the secondary shaft portion 34 in design or designing a toroidal type continuously variable transmission whose secondary shaft portion 34 has a different shaft diameter, the gear ratio control has to be reconsidered.

### SUMMARY OF THE INVENTION

The invention was made in the light of the aforesaid situations and one of objects thereof is to provide a toroidal type continuously variable transmission which can suppress the variability of the behavior of the gear ratio so as to maintain the gear ratio stably and can continue to use the same gear ratio control even for a different model type of support shaft for supporting rotatably a power roller which differs in shaft diameter.

With a view to accomplishing the aforesaid object, according to a first aspect of the invention, there is provided a toroidal type continuously variable transmission comprising:

an input disk and an output disk supported rotatably and concentrically with each other in a state that respective inner surfaces thereof oppose to each other;

a plurality of trunnions adapted to swing around respective pivot shafts provided at twisted positions with relative to a central axis of the input disk and the output disk;

a plurality of power rollers held between the input disk and the output disk;

a driving device for shifting the respective trunnions in an axial direction of the pivot shafts,
a supporting shaft extending in a rotational axis of the power roller from the trunnion; and

a thrust ball bearing disposed between the power roller and the trunnion, wherein
the power roller is rotatably supported on the trunnion via the supporting shaft and the thrust ball bearing,
the support shaft is fitted to an outer race of the thrust ball bearing by inserting the support shaft to a hole formed in a central portion of the outer race, and
a clearance amount between the hole in the outer race and the support shaft is set within a range from 0 to 0.05 mm.

According to a second aspect of the present invention, there is provided a manufacturing method for plurality of toroidal type continuously variable transmissions each of which comprise:

an input disk and an output disk supported rotatably and concentrically with each other in a state that respective inner surfaces thereof oppose to each other;

a plurality of trunnions adapted to swing around respective pivot shafts provided at twisted positions with relative to a central axis of the input disk and the output disk;

a plurality of power rollers held between the input disk and the output disk;

a driving device for shifting the respective trunnions in an axial direction of the pivot shafts,
a supporting shaft extending in a rotational axis of the power roller from the trunnion; and

a thrust ball bearing disposed between the power roller and the trunnion, wherein
the power roller is rotatably supported on the trunnion via the supporting shaft and the thrust ball bearing, and
the support shaft is fitted to an outer race of the thrust ball bearing by inserting the support shaft to a hole formed in a central portion of the outer race,
the manufacturing method comprising the steps of:

setting a constant target value of a clearance amount between the hole in the outer race and the support shaft, whenever diameter of the respective support shafts of each toroidal type continuous variable transmissions are the same or different from each other; and

machining the hole in the outer race and the support shaft so as to make the clearance therebetween in a range from 0 to 0.05 mm by using thus set constant target value.

Note that the target value of the clearance amount means an intermediate value of the clearance amount between the hole in the outer race and the support shaft.

According to an aspect of the invention, the aforesaid variability of the clearance amount can be suppressed so as to maintain stably the predetermined target gear ratio by making the clearance amount between the hole in the outer race and the support shaft remain at the predetermined constant value even when the shaft diameter of the support shaft differs and making the target value fall within the range from 0 to 0.05 mm. In addition, since, even in toroidal type continuously variable transmissions of different model types in which the support shafts differ in shaft diameter, the same gear ratio can be maintained stably, the same gear ratio control can be implemented even for support shafts having different shaft diameters, thereby making it possible to reduce costs that would otherwise by incurred for a change in the gear ratio control method which has to occur in association with a change in shaft diameter.

According to the toroidal type continuously variable transmission of the invention, the variation of the clearance amount can be suppressed so as to maintain stably the predetermined target gear ratio, and substantially the same gear ratio control can continue to be used even when there occurs a change in the shaft diameter of the support shaft of the power roller, thereby making it possible to reduce costs that would otherwise by incurred for a change in the gear ratio control method which has to occur in association with a change in shaft diameter.

### BRIEF DESCRIPTION OF THE DRAWINGS

FIG. 1 is a sectional view of a main part of a toroidal type continuously variable transmission according to an embodiment of the invention;

FIG. 2 is a sectional view showing a power roller which is rotatably supported on a trunnion of the toroidal type continuously variable transmission;

FIG. 3 is an enlarged view of a portion indicated by reference character Z in FIG. 2;

FIG. 4 is a sectional view showing the power roller which is rotatably supported on the trunnion of the toroidal type continuously variable transmission;

FIG. 5 is a side view showing a basic configuration of the toroidal type continuously variable transmission which results at the time of maximum reduction in speed;

FIG. 6 is a side view showing a basic configuration of the toroidal type continuously variable transmission which results at the time of maximum increase in speed;

FIG. 7 is a sectional view showing an example of a specific construction of a double-cavity toroidal type continuously variable transmission; and

FIG. 8 is a sectional view taken along the line B-B in FIG. 7.

### DETAILED DESCRIPTION OF THE PREFERRED EMBODIMENTS

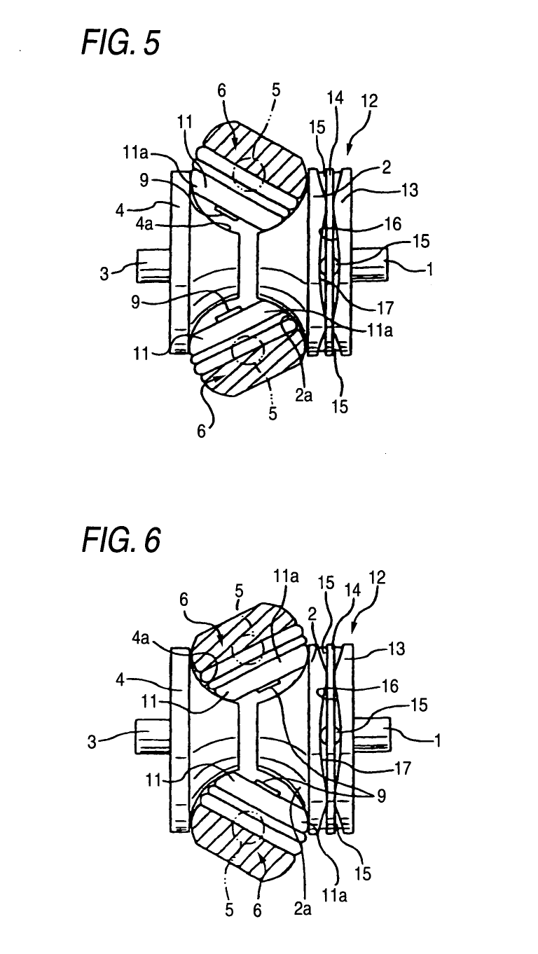

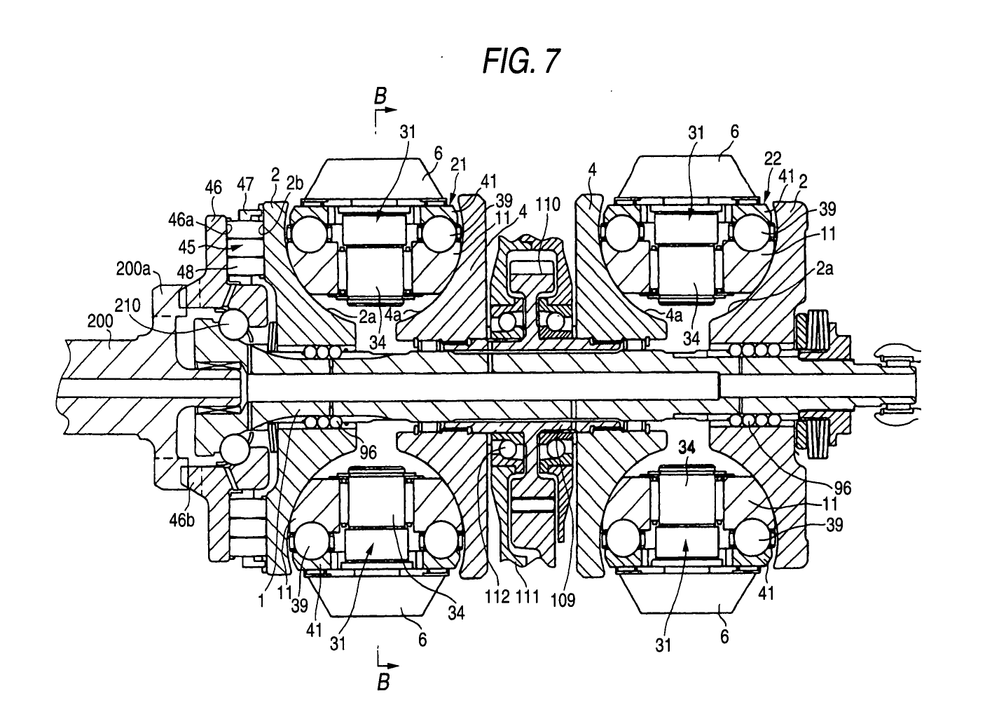

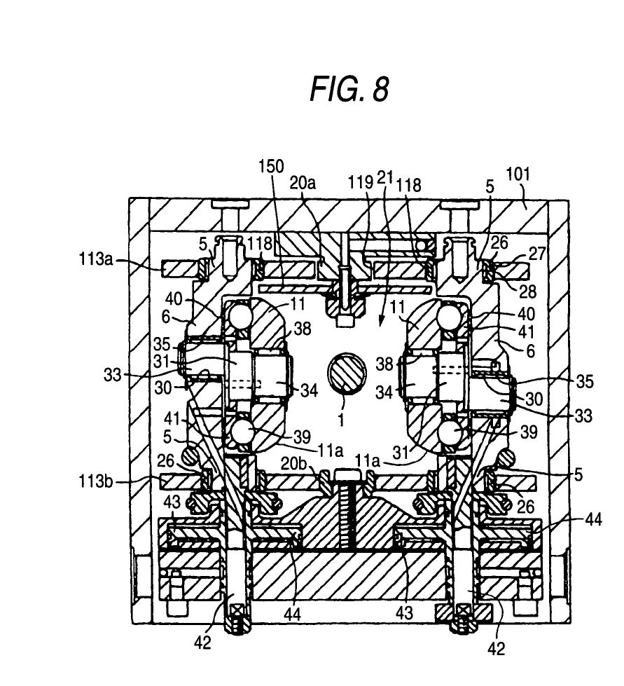

Hereinafter, referring to the accompanying drawings, a mode for carrying out the invention will be described. Note that the characteristics of the invention reside in points that a clearance amount between the hole in the outer race and the support shaft is made to remain at a predetermined constant value even when the shaft diameter of the support shaft differs and that the target clearance amount is set within a range from 0 to 0.05 mm, and the configuration and function of the remaining parts of the invention remain the same as the afore-described example. In a following description, mainly portions characteristic of the invention will be explained, and as to the other portions thereof, like reference numerals will be imparted to like portions to those described by reference to FIGS. 5 to 8, so as to simplify the description.

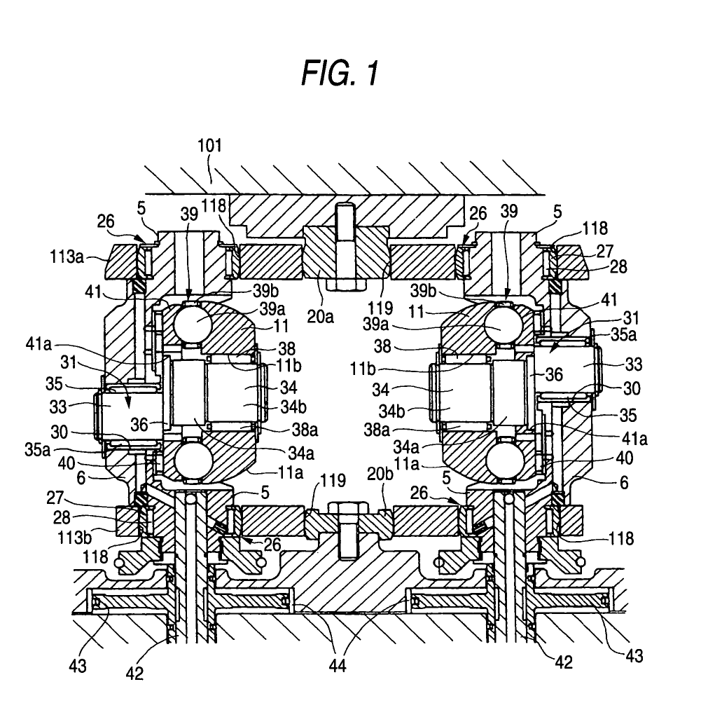

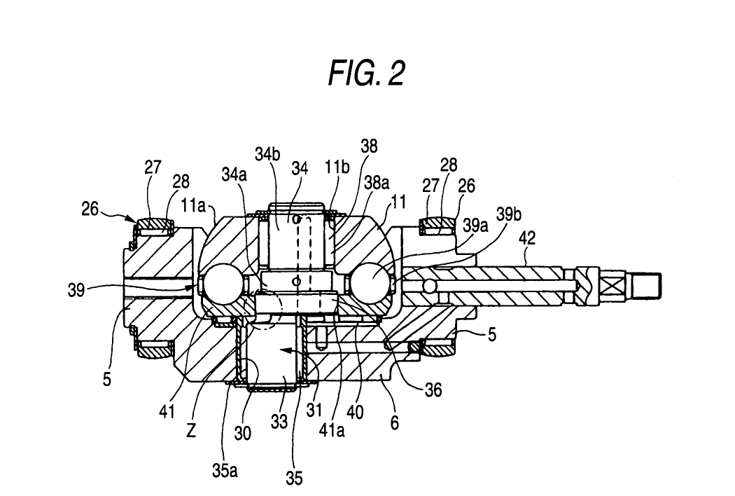

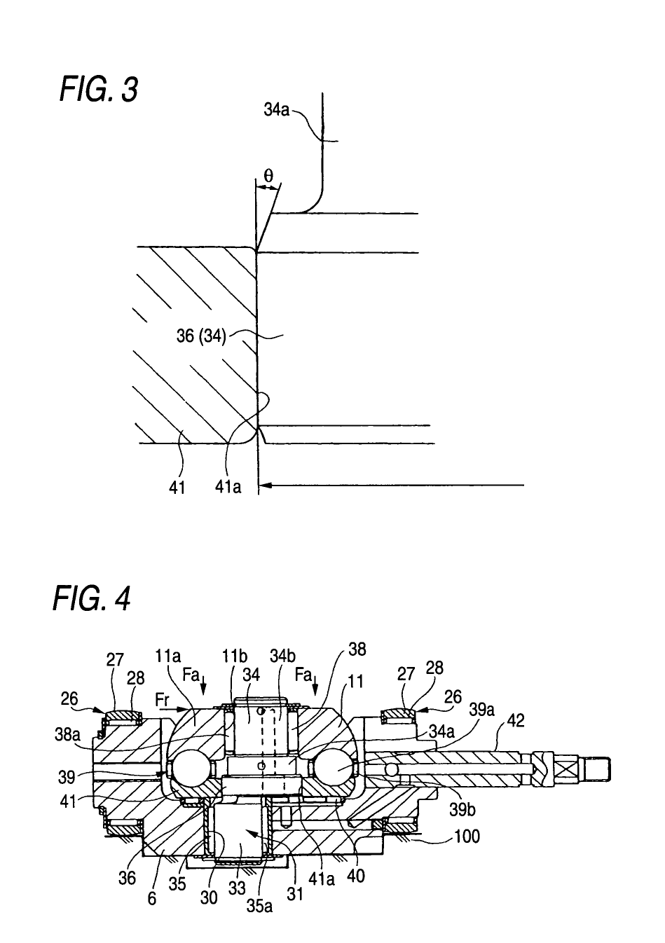

FIG. 1 shows two power rollers 11, 11 which oppose to each other and two trunnions 6 which supports the power rollers 11, 11, respectively, of a toroidal type continuously variable transmission according to an embodiment of the invention. FIG. 2 shows the power roller 11 supported by the trunnion 6. FIG. 3 is an enlarged view showing part indicated by reference character Z in FIG. 2.

Here, a displacement shaft 31, a hole 41a in an outer race 41 of a thrust ball bearing 39, and a fitting construction thereof will be described in greater detail.

As shown in FIGS. 1 to 3, the displacement shaft 31 has a primary shaft portion 33 and a secondary shaft portion 34 which are in parallel with and eccentric to each other.

In addition, the secondary shaft portion 34 constitutes a support shaft which supports the power roller 11. A disk-like flange or collar portion 36 is formed at a proximal end portion of the secondary shaft portion 34 in a region where the first shaft portion 33 continues to the second shaft portion 34.

In addition, the secondary shaft portion 34 has the collar portion 36 which continues to the primary shaft portion 33, a proximal half portion 34a which continues to the collar portion 36 and a distal half portion 34b which continues to the proximal half portion 34a, and these collar portion 36, the proximal half portion 34a and the distal half portion 34b are disposed concentrically in this order.

Additionally, as shown in FIGS. 2 and 3, the disk-like collar portion 36 is inserted to be fitted in the hole 41a in the outer race 41, an axial length (thickness) of the disk-like collar portion 36 is made substantially the same as the axial length (thickness) of the outer race 41.

In addition, the diameter of the collar portion 36 becomes a shaft diameter of a support shaft when the secondary shaft portion 34, which functions as the support shaft, is fitted in the hole 41a in the outer race 41.

The diameter of the secondary shaft portion 34 is reduced in a stepping down fashion at the collar portion 36, the proximal half portion 34a and the distal half portion 34b in this order. The diameter of the secondary shaft portion 34 becomes maximum at the collar portion 36. Here, there is produced a difference in level at a portion where the collar portion 36 continues to the proximal half portion 34a due to the diameter of the collar portion 36 being larger than the diameter of the proximal half portion 34a, as shown in FIG. 3.

Here, when the secondary shaft portion 34 is fitted in the hole 41a in the outer race 41 in assembling the toroidal type continuously variable transmission, the diameters of the distal half portion 34b and the proximal half portion 34a are smaller than an inner diameter of the hole 41a in the outer race 41, because the distal half portion 34b and the proximal half portion 34a are made smaller in diameter than the collar portion 36. Consequently, the distal half portion 34b and the proximal half portion 34a can easily be inserted into the hole 41a in the outer race 41.

However, the amount of a clearance that is produced between the collar portion 36, which lies behind the distal half portion 34a and the proximal half portion 34b, and the inner diameter of the hole 41a in the outer race 41 is set to be in the range from 0 to 0.05 mm, in order to facilitate an insertion of the collar portion 36 into the hole 41a in the outer race 41. Thus, a portion of the collar portion 36 which constitutes an elevated portion (a portion to be inserted into the hole 41a) continuing to the proximal half portion 34a is chamfered. As shown in FIG. 3, a chamfering angle θ may be made to range from 3 to 30 degrees, for example. Namely, an outer circumferential portion of a side of the collar portion 36 which is to be inserted into the hole 41a is chamfered, and the chamfering angle is made to range from 3 to 30 degrees, whereby, even though the clearance amount between the hole 41a and the collar portion 36 is set to be in the range from 0 to 0.05 mm, the collar portion 36 can be inserted into the hole 41a relatively easily.

In the embodiment of the invention, as shown in FIGS. 2 and 3, only the collar portion 36 is made to be fitted in the hole 41a in the outer race 41 by setting the diameter of the hole 41a in the outer race 41 the same along the full length in the axial direction or thickness thereof and by setting the thickness of the hole 41a substantially the same as that of the collar portion 36. Note that, in addition to the collar portion 36, a part of the proximal half portion 34a which continues from the collar portion 36 may be made to be fitted in the hole 41a in the outer race, as shown in FIG. 1. In this case, a difference in level like the one produced between the collar portion 36 and the proximal half portion 34a is formed on the hole 41a in the outer ring 41 so as to follow a shape of the part of the proximal half portion 34a. Namely, the diameter of the hole 41 in the outer race 41 is diametrically expanded at a rear side thereof so as to correspond to the shaft diameter of the collar portion 36, whereas the hole 41a in the outer race 41 is diametrically narrowed at a leading side thereof so as to correspond to the shaft diameter of the proximal half portion 34a.

In this case, the respective shaft diameters of the collar portion 36 and the proximal half portion 34a of the secondary shaft portion 34 correspond to the shaft diameter of the support shaft, the clearance between the diametrically narrow portion of the hole 41a in the outer race 41 and the proximal portion 34a is made to be in the range from 0 to 0.05 mm, and the clearance between the diametrically wide portion of the hole 41a in the outer race 41 and the collar portion 36 is made to be in the range from 0 to 0.05 mm. In addition, a target value, which will be described later on, of the clearance amount between the diametrically narrow portion of the hole 41a in the outer race 41 and the proximal half portion 34a is made to be, for example, 0.025 mm, and a target value of the clearance amount between the diametrically wide portion of the hole 41a in the outer race 41 and the collar portion 36 is made to be, for example, 0.025 mm.

The diameter of the primary shaft portion 33 which eccentrically continues to a rear end of the collar portion 36 of the secondary shaft portion 34 is made substantially the same as that of the distal half portion 34b of the secondary shaft portion 34. Then, as has been described above, the primary shaft portion 33 is inserted into a circular hole 30 in the trunnion 6, and a plurality of needles 35a are rollingly disposed between an outer circumference of the primary shaft portion 33 and an inner circumference of the circular hole 30 to thereby make up a radial needle roller bearing 35.

Additionally, the distal half portion 34b of the secondary shaft portion 34 is inserted into a circular hole 11b provided in the power roller 11, and a plurality of needles 38a are rolling disposed between an outer circumference of the distal half portion 34b and an inner circumference of the circular hole 11b in the power roller 11 to thereby make up a radial needle roller bearing 38.

A plurality of balls 39a are retained rollingly on a predetermined raceway by a cage 39a as rolling elements between the outer race 41 and the power roller 11 to thereby make up a thrust ball bearing 39. Note that the proximal half portion 34a of the secondary shaft portion 34 is disposed in a central portion of this thrust ball bearing 39.

Additionally, a thrust bearing (a thrust needle roller bearing) 40 is disposed between the trunnion 6 and the outer race 41.

In this embodiment, in fitting the collar portion 36 of the secondary shaft portion 34, which makes up the support shaft, in the hole 41a in the outer race 41, the target value of the clearance amount between the hole 41a and the collar portion 36 is designed to remain at a predetermined constant value even though the shaft diameter of the support shaft (the collar portion 36) differs and the hole 41a and the collar portion 36 are machined so as to produce and keep the target value. In addition, the clearance amount is made to fall within the range from 0 to 0.05 mm.

Here, the target value of the clearance amount is made to be 0.025 mm which constitutes an intermediate value of the clearance amount range of 0 to 0.05 mm.

Conventionally, when manufacturing members which are fitted each other are machined by using a common Tolerance as shown in Table 1. Thus, when manufacturing members having different shaft diameter each other, different Tolerance are used. Thus, the offset amount differs in plurality of toroidal type continuous variable transmissions.

However, the present invention apply a common Tolerance whenever diameter of the respective support shafts of each toroidal type continuous variable transmissions are the same or different from each other.

That is, at first, a predetermined constant target value are set for a clearance amount formed between the hole in the outer race and the support shaft. Subsequently, machining the hole in the outer race and the support shaft so as to make the clearance therebetween in a range from 0 to 0.05 mm by using thus set constant target value.

Here, as has been described before, the primary shaft portion 33 of the displacement shaft 31 is rotatably supported in the circular hole 30 in the trunnion 6 by means of the radial needle roller bearing 35, and the power roller 11 is rotatably supported on the secondary shaft portion 34 via the radial needle roller bearing 38. In this constitution, because the radial needle roller bearings 35, 38 has clearance which allows their shaft to tilt, the displacement shaft 31 and the power roller 11 tilt relative to the trunnion 6 and the displacement shaft 31, respectively. Accordingly, the rotational center of the power roller 11 is allowed to be offset in the direction of the pivot shaft 5 of the trunnion 6.

When a thrust force indicated by reference character Fa in FIG. 4 is applied to the power roller 11, the outer race 41 is pressed towards the trunnion 6 and the power roller 11 is pressed towards the outer race 41. In this circumstance, as has been described above, the clearance amount between the hole 41a in the outer race 41 and the shaft diameter (e.g. the shaft diameter of the collar portion 36) of the support shaft (the secondary shaft portion 34) set to a constant value in a range of 0 to 0.05 mm. Therefore, the offset amount of the rotational center of the power roller 11 due to the aforesaid tilting is restricted based on the constant clearance amount produced at the fitting portion between the hole 41a in the outer race 41 and the support shaft (the secondary shaft portion 34).

In particular, when the shaft diameter is thick, the clearance amount of the present invention is set relatively smaller than the conventional clearance amount, thus, the offset amount also restricted to be small.

Consequently, a predetermined target gear ratio can be maintained in a stable fashion. Namely, the shift amount (offset amount) of the power roller can be suppressed which is produced when there occurs a change in the magnitude of torque that is transmitted via the toroidal type continuously variable transmission and a force is applied to the power roller 11 in the direction of the pivot shaft (tilt shaft), so as to suppress the effect on the gear ratio.

In addition, even when the shaft diameter (the shaft diameter of the collar portion 36) of the support shaft (the displacement shaft 31) differs, by making the clearance amount fall within the same range, the behavior of the gear ratio which fluctuates can be made to stay in substantially the same state even though there occurs the aforesaid torque change. Therefore, substantially the same gear ratio control can be implemented. Consequently, even though the shaft diameter of the support shaft is changed, the gear ratio control dose not have to be reconsidered largely, thereby making it possible to reduce the costs.

Note that while the clearance amount is made to range from 0 to 0.05 mm, the clearance amount may be made smaller with a view to restricting the offset amount of the power roller 11, that is, the clearance amount may be made to range from 0 to 0.04 mm. In addition, when the clearance amount is made to range from 0 to 0.04 mm, the target value of the clearance amount is made to be, for example, 0.02 mm which makes an intermediate value of the range from 0 to 0.04 mm.

Consequently, the target value of the clearance amount may be made to fall within a range from 0.02 to 0.025 mm.

### Embodiment

While a specific embodiment of the invention will be described below, the invention is not limited thereto.

In this embodiment, a target value of the amount of a clearance produced between a hole 41a (a diametrically wide portion and a diametrically narrow portion) in an outer race 41 and a secondary shaft portion 34 (a proximal half portion 34a of a collar portion 36) as a support shaft is set to be 0.02 mm and a clearance amount resulting after fabrication made to fall within a range from 0 to 0.04 mm. a plurality of samples which represent a portion of a power roller 11 supported on a trunnion 6 of a toroidal type continuously variable transmission shown in FIG. 4 were actually prepared. In producing the samples, there were produced samples having collar portions 36 whose shaft diameter is φ28 (mm) and samples having collar portions 36 whose shaft diameter is φ33 (mm).

In FIG. 4, the trunnion 6 on which the power roller 11 was mounted was fixedly set on a table 100, and a radial force Fr was applied in a pivot shaft direction (in a tilt shaft direction) in such a state that a thrust force indicated by reference character Fa was applied for measurement of a loosened amount (a displaced amount (mm)) of the power roller 11 in the tilt shaft direction. Note that the radial force applied then was 1960N (200 kgf).

Measured loosened amounts, which are the results of the measurement, are shown in Table 2 below. Note that as described above, at least the clearance amount affects the loosened amount as shown in Table 2.

TABLE 2

| sample No. | samples with φ28 | samples with φ33 |
|---|---|---|
| 1 | 0.557 | 0.502 |
| 2 | 0.528 | 0.546 |
| 3 | 0.553 | 0.496 |
| 4 | 0.537 | 0.504 |
| average | 0.544 | 0.512 |

unit mm

As shown in Table 2, by setting the target value of the clearance amount to 0.02 mm both for the shaft diameter of φ28 and the shaft diameter of φ33 and making the clearance amount to range from 0 to 0.04 mm, values of the loosened amounts corresponding to the aforesaid offset amount of the power roller became approximate to each other even though the shaft diameter differed. It is seen from the results that by making the target value of the clearance amount the same even though the shaft diameter differs, it becomes possible to prevent the behavior of the gear ratio from being caused to differ due to the offset amount which changes with the shaft diameter differing.

In addition, because there appears a tendency where the loosened amount becomes smaller with φ33 than with φ28, even if the target value of the clearance amount is slightly increased from 0.02 mm, the aforesaid advantage is highly liable to be obtained, and it is well assumed that the target value of the clearance amount may be made to be 0.025 mm as has been described above and the clearance amount made to range from 0 to 0.05 mm.

The invention can be applied to various types of single-cavity or double-cavity half toroidal type continuously variable transmissions.

While there has been described in connection with the preferred embodiments of the present invention, it will be obvious to those skilled in the art that various changes and modification may be made therein without departing from the present invention, and it is aimed, therefore, to cover in the appended claim all such changes and modifications as fall within the true spirit and scope of the present invention.

What is claimed is:

1. A toroidal type continuously variable transmission comprising:
an input disk and an output disk supported rotatably and concentrically with each other in a state that respective inner surfaces thereof oppose to each other;
a plurality of trunnions adapted to swing around respective pivot shafts provided at twisted positions with relative to a central axis of the input disk and the output disk;
a plurality of power rollers held between the input disk and the output disk;
a driving device for shifting the respective trunnions in an axial direction of the pivot shafts,
a supporting shaft extending in a rotational axis of the power roller from the trunnion; and
a thrust ball bearing disposed between the power roller and the trunnion, wherein
the power roller is rotatably supported on the trunnion via the supporting shaft and the thrust ball bearing,
the support shaft is fitted to an outer race of the thrust ball bearing by inserting the support shaft to a hole formed in a central portion of the outer race, and
a clearance amount between the hole in the outer race and the support shaft is set within a range from 0 to 0.05 mm.

2. A manufacturing method for plurality of toroidal type continuously variable transmissions each of which comprise:
an input disk and an output disk supported rotatably and concentrically with each other in a state that respective inner surfaces thereof oppose to each other;
a plurality of trunnions adapted to swing around respective pivot shafts provided at twisted positions with relative to a central axis of the input disk and the output disk;
a plurality of power rollers held between the input disk and the output disk;
a driving device for shifting the respective trunnions in an axial direction of the pivot shafts,
a supporting shaft extending in a rotational axis of the power roller from the trunnion; and
a thrust ball bearing disposed between the power roller and the trunnion, wherein
the power roller is rotatably supported on the trunnion via the supporting shaft and the thrust ball bearing, and
the support shaft is fitted to an outer race of the thrust ball bearing by inserting the support shaft to a hole formed in a central portion of the outer race,
the manufacturing method comprising the steps of:
setting a constant target value of a clearance amount between the hole in the outer race and the support shaft, whenever diameter of the respective support shafts of each toroidal type continuous variable transmissions are the same or different from each other; and
machining the hole in the outer race and the support shaft so as to make the clearance therebetween in a range from 0 to 0.05 mm by using thus set constant target value.
